(19) United States
(12) Patent Application Publication
(10) Pub. No.: US 2008/0207250 A1
(43) Pub. Date: Aug. 28, 2008

(54) Apparatus and method for reverse power control in mobile communication system

(75) Inventors: Goo-Hyun Park, Yongin-si (KR); Sung-Kwon Jo, Suwon-si (KR); Ji-Hoon Choi, Gangnam-gu (KR)

Correspondence Address: DOCKET CLERK, P.O. DRAWER 800889, DALLAS, TX, 75380, US

(73) Assignee: SAMSUNG ELECTRONICS CO., LTD., Suwon-si (KR)

(21) Appl. No.: 12/072,078

(22) Filed: Feb. 22, 2008

(30) Foreign Application Priority Data
Feb. 23, 2007 (KR) 2007-0018236

(51) Int. Cl. H04B 7/005; H04B 7/26

(52) U.S. Cl. 455/522; 455/69

(57) ABSTRACT

An uplink power control method of a base station (BS) in a m obile communication system is provided. The method includes rece iving a signal from a terminal; calculating an RSQI value using t he signal and previous power control information; comparing the R SQI with a threshold; determining power control information after the comparison; sending the power control information to the ter minal.

### CROSS-REFERENCE TO RELATED APPLICATION(S) AND CLAIM OF PRIORITY

The present application claims priority under 35 U.S.C. §119(a) to an application filed in the Korean Intellectual Property Office on Feb. 23, 2007 and assigned Serial No. 2007-18236, the disclosure of which is herein incorporated by reference.

### TECHNICAL FIELD OF THE INVENTION

The present invention relates generally to a reverse power control. More particularly, the present invention relates to an apparatus and a method for improving accuracy when measuring a Received Signal Quality Indicator (RSQI) value indicative of a quality of a reverse link for a power control of the reverse link in a base station of a mobile communication system.

### BACKGROUND OF THE INVENTION

Code Division Multiple Access (CDMA) mobile communication systems perform a power control to maintain a constant signal level of a terminal, which is received at a base station, to ensure an efficient operation and a stable performance.

The power control schemes include an open-loop power control and a closed-loop power control. Typically, the open-loop power control exhibits good performance with respect to a long-term fading, whereas the closed-loop power control exhibits good performance with respect to a short-term fading.

The closed-loop power control measures a quality of a signal received from the terminal and sends a command to control the transmit power to the terminal to maintain the constant quality of the signals received from the base station. In the closed-loop power control, the base station sends a Power Control Bit (PCB) to the terminal and the terminal increases or decreases the power to a specific dB level according to the PCB received from the base station.

In the downtown area, a shadowing on/off, which abruptly changes the reverse power control by 30 to 40 dB, frequently occurs because of considerable changes in the Line-Of-Sight (LOS), depending on whether there are obstacles such as buildings in the reverse link. That is, the presence or absence of the obstacles in the reverse path greatly changes the LOS.

In response to the abrupt change of the power control, standard specifications adopt a fast power control which performs the closed-loop power control in short periods.

For example, while CDMA 2000 1× EVolution Data Only (EV-DO) Rev. 0 standard performs the closed-loop power control in periods of 150 Hz, the improved standard CDMA 2000 1× EV-DO Rev. A performs the closed-loop power control in periods of 600 Hz. The fast closed-loop power control can maintain the stable performance in an environment where the abrupt power loss change frequently such as shadowing on/off in the downtown area occurs.

However, the fast closed-loop power control is subject to the low accuracy when measuring the reverse link because it measures the quality of the reverse link during the short term.

FIG. 1 depicts a general reverse power control.

The base station (BS) Received (Rx) Signal Strength Indication (RSSI) 110 of FIG. 1 generates PCBs using the quality of the reverse link measured for 6.67 msec. in the 150 Hz closed-loop power control but measures the quality of the reverse link for 1.67 msec. in the 600 Hz closed-loop power control in step 140. Next, the BS generates and sends BS Transmit (Tx) PCBs 120 to the mobile station (MS). Accordingly, the MS Tx gain 130 is adjusted.

In the fast closed-loop power control, errors in the measurement of the reverse link quality may cause inaccurate power control. As a result, the strength of the reverse signal received to the BS is apt to be unstable and to change severely.

However, when the time required to measure the quality of the reverse link is increased to raise the accuracy of the reverse link quality measurement, the signal of the power level already changed by the previous power control command is included to thus misrepresent the RSQI value in the measurement of the reverse link quality.

### SUMMARY OF THE INVENTION

To address the above-discussed deficiencies of the prior art, it is a primary aspect of the present invention to substantially solve at least the above problems and/or disadvantages and to provide at least the advantages below. Accordingly, an aspect of the present invention is to provide an apparatus and a method for a reverse power control in a mobile communication system.

Another aspect of the present invention is to provide an apparatus and a method for achieving an efficient base station (BS) operation and an enhanced decoding performance by improving accuracy in measurement of RSQI value indicative of a quality of a reverse link for a power control of the reverse link in a base station of a mobile communication system.

The above aspects are achieved by providing an uplink power control method of a base station (BS) in a mobile communication system. The method includes receiving a signal from a terminal; calculating an RSQI value using the signal and previous power control information; comparing the RSQI with a threshold; determining power control information after the comparison; sending the power control information to the terminal.

According to one aspect of the present invention, a base station BS for controlling an uplink power in a mobile communication system includes a communication module for communicating with other nodes; a controller receiving a signal from a terminal through the communication module, calculating an RSQI value using the signal and previous power control information, determining power control information by comparing the RSQI with a threshold, and sending the power control information to the terminal; and a storage for storing the RSQI and data of the controller.

According to another aspect of the present invention, a system for controlling an uplink power in a mobile communication system includes a terminal for sending a signal with an instructed strength; and a base station (BS) for receiving the signal from the terminal through a communication module, calculating a RSQI using the signal and previous power control information, determining power control information by comparing the RSQI with a threshold, and sending the power control information to the terminal.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a diagram of a general reverse power control;

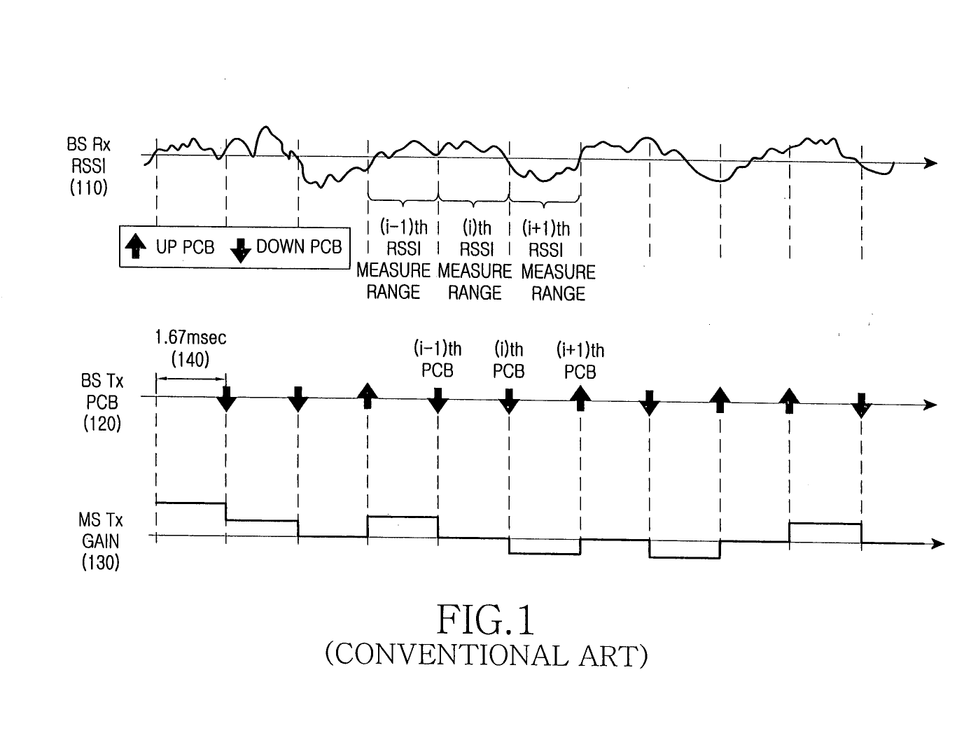

FIG. 2 is a block diagram of an RSQI manager for a reverse power control according to an embodiment of the present invention;

FIG. 3 is a flowchart of a reverse power control method according to an embodiment of the present invention;

FIG. 4 is a block diagram of a network device according to an embodiment of the present invention;

FIG. 5 is a diagram of a performance in the reverse power control according to an embodiment of the present invention; and

FIG. 6 is a diagram of a performance in the reverse power control according to an embodiment of the present invention.

### DETAILED DESCRIPTION OF THE INVENTION

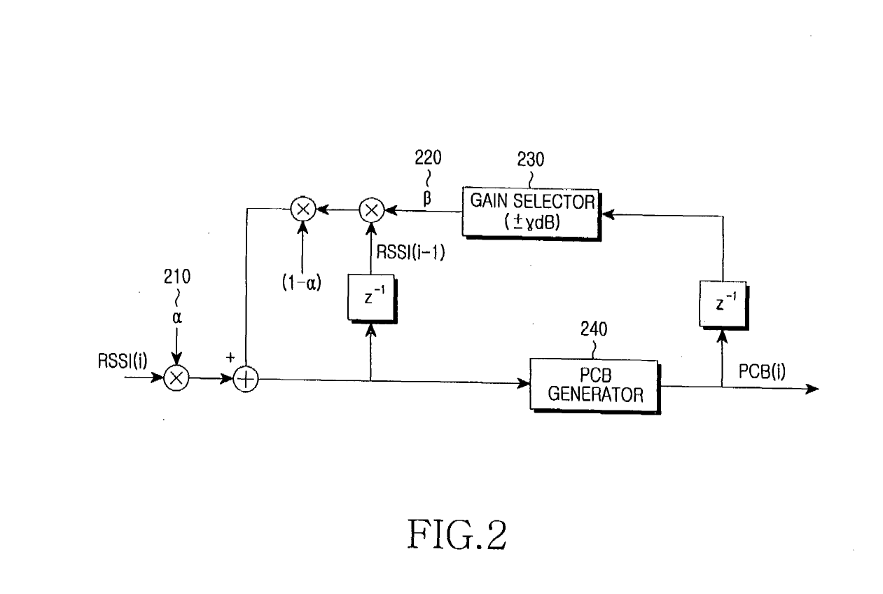

FIGS. 2 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

The present invention provides an apparatus and a method for a reverse power control in a mobile communication system to acquire accuracy in measuring a Received Signal Quality Indicator (RSQI) indicative of a quality of a reverse link.

FIG. 2 is a block diagram of an RSQI manager for a reverse power control according to an embodiment of the present invention.

The RSQI manager of FIG. 2 includes a 1-tap Infinite Impulse Response (IIR) filter and gain selector 230 and a power control generator (hereafter, referred to as a Power Control Bit (PCB) generator) 240.

An RSQI measurement value RSQI(i) is generated based on Equation 1:

RSQI(i)=α·rsqi(i)+(1−α)·β(i−1)·RSQI(i−1) [Eqn. 1]

In Equation 1, RSQI(i) is an RSQI value measured for half of the i-th power control period, α 210 is a learning factor of the 1-tap IIR filter, and β 220 is a power control quantity which is determined based on Equation 2.

The learning factor can be acquired through tests, simulations, or mathematical calculations:

if (PCB(i−1)=UP)β=10^{(γ/10)}

else if (PCB(i−1)=DOWN)β=10^{(-γ/10)}^{^{.}} [Eqn. 2]

In Equation 2, γ is one predefined closed-loop power control quantity, of which unit is [dB]. The gain selector 230 calculates γ. PCB(i−1) is previous power control information.

When RSQI(i) is acquired using Equation 1, the PCB generator 240 compares RSQI(i) with a threshold and then generates PCB(i). For example, when RSQI(i) is greater than the threshold, the PCB generator 240 generates a PCB instructing the power down. When RSQI(i) is smaller than the threshold, the PCB generator 240 generates PCB instructing the power up. PCB(i) is transmitted to a terminal.

To apply the (i−1)-th RSQI value to the i-th measured value without a distortion, the BS uses the (i−1)-th PCB generated by measuring the (i−1)-th RSQI, to measure the i-th RSQI. That is, the gain as much as the power control quantity β(i−1) applied to the i-th time is compensated using the (i−1)-th PCB information transmitted to the terminal in the (i−1)-th time and used for the power control, and then applied for the IIR filtering.

For example, when the (i−1)-th PCB generated indicates the power down and the power quantity controlled by one time is 1 dB, it is expected that the i-th instantaneous RSQI value measured is smaller than the (i−1)-th instantaneous RSQI measured by 1 dB.

Accordingly, for using the (i−1)-th RSQI to measure the i-th RSQI, the gain of −1 dB is given to the (i−1)-th RSQI. Herein, the (i−1)-th PCB information is already known to the BS because it is generated by the BS and transmitted to the terminal. The PCB information generated at the BS is transmitted to the terminal in a forward link. Since the forward link also suffers error, it is necessary to take into account the PCB error rate transmitted in the forward link when determining the learning factor α 210.

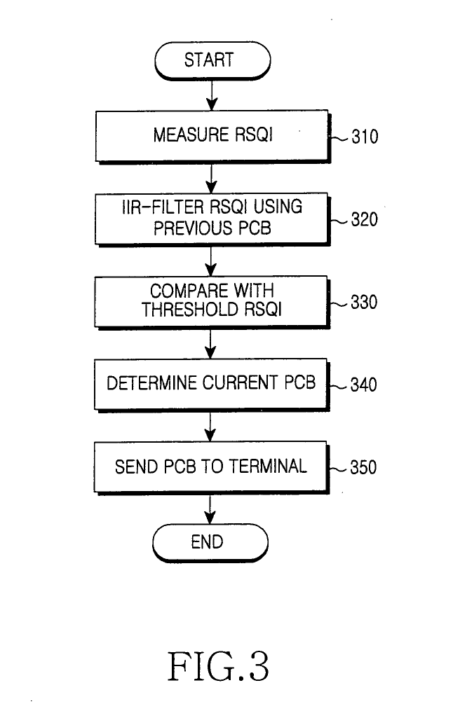

FIG. 3 is a flowchart of a reverse power control method according to an embodiment of the present invention.

The BS measures the current RSQI in step 310, and IIR-filters the RSQI of the current period using the PCB of the previous period in step 320.

The BS compares the filtered RSQI with the threshold RSQI in step 330 and determines the PCB of the current period in step 340. Next, the BS sends the determined PCB to the terminal in step 350.

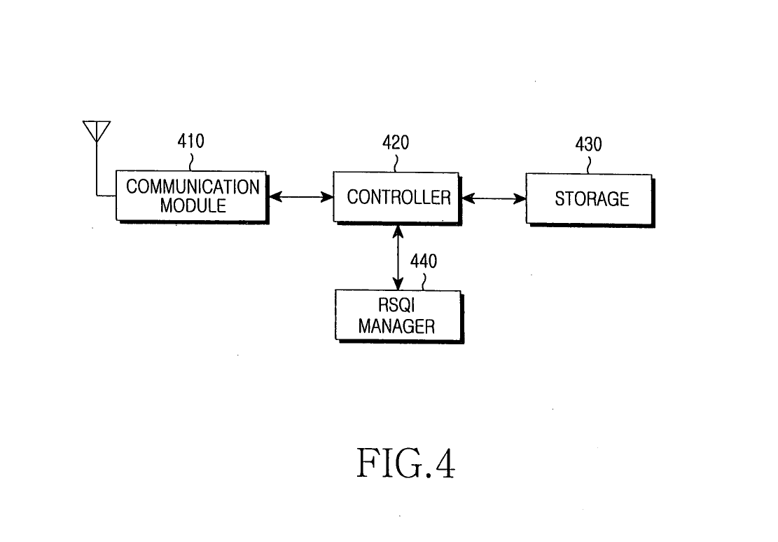

FIG. 4 is a block diagram of a network device according to an embodiment of the present invention.

A communication module 410 includes a wired processing module, a wireless processing module, and a baseband processing module for communicating with other nodes. The wireless processing module converts a signal received on an antenna to a baseband signal and provides the baseband signal to the baseband processing module. The wireless processing module converts a baseband signal output from the baseband processing module to a Radio Frequency (RF) signal transmittable over the air and sends the RF signal over the antenna. The wired processing module converts a signal received in a wired path to a baseband signal and provides the baseband signal to the baseband processing module. The wired processing module converts a baseband signal output from the baseband processing module to a corresponding wired signal transmittable by cable and sends the wired signal through the connected cable.

A controller 420 performs basic processing and controlling of the device. For example, the controller 420 processes and controls voice communications and data communications. In addition to typical functions, the controller 420 raises the accuracy of the RSQI measurement by controlling an RSQI manager 440.

A storage 430 stores programs for controlling the operations of the device and temporary data generating in the program executions.

The RSQI manager 440 increases the accuracy of the RSQI measurement using the IIR filtering according to the direction and the information from the controller 420, generates and transmits the corresponding PCB to the terminal.

As constructed above, the controller 420 can function as the RSQI manager 440. The controller 420 and the RSQI manager 440 are separately provided to distinguish their functions. In the actual implementation, the controller 420 may process all or part of the functions of the RSQI manager 440.

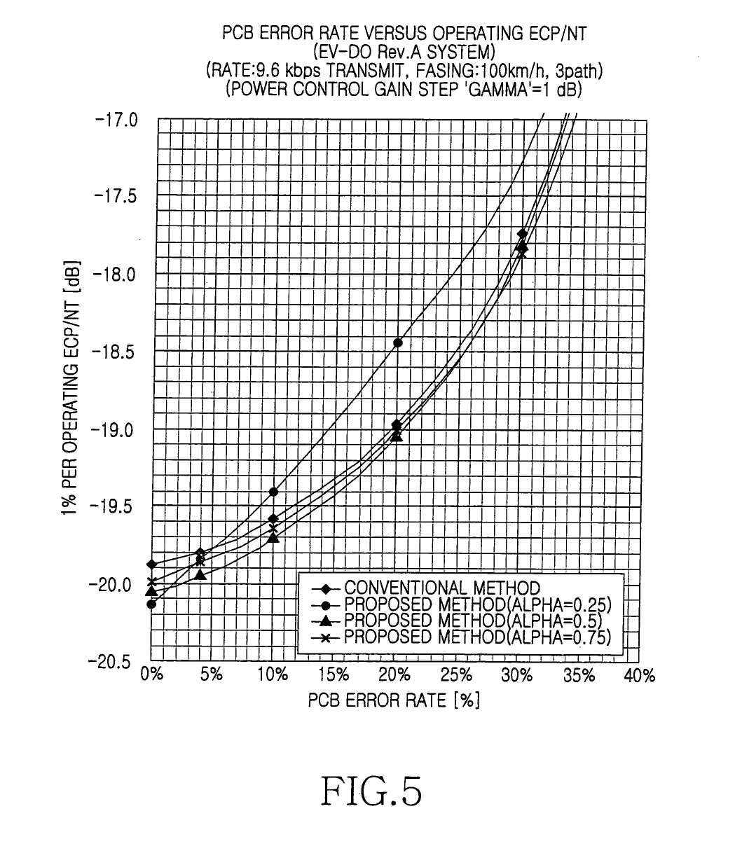

FIG. 5 is a diagram of a performance in the reverse power control according to an embodiment of the present invention

When the present invention is applied to the CDMA 2000 1× EV-DO Rev.A system, operating SNRs which maintain 1% PER according to the error rate of the PCB being the power control information transmitted in the forward link, are depicted in FIG. 5.

When the learning factor is set to below 0.5, the present invention can guarantee the stable performance enhancement, compared with the conventional method.

Since the error rate of the power control information transmitted in the forward link is generally set to 4% or so, the performance can improve by 0.15˜0.2 [dB] in the condition of 100 km/h and 3-path fading.

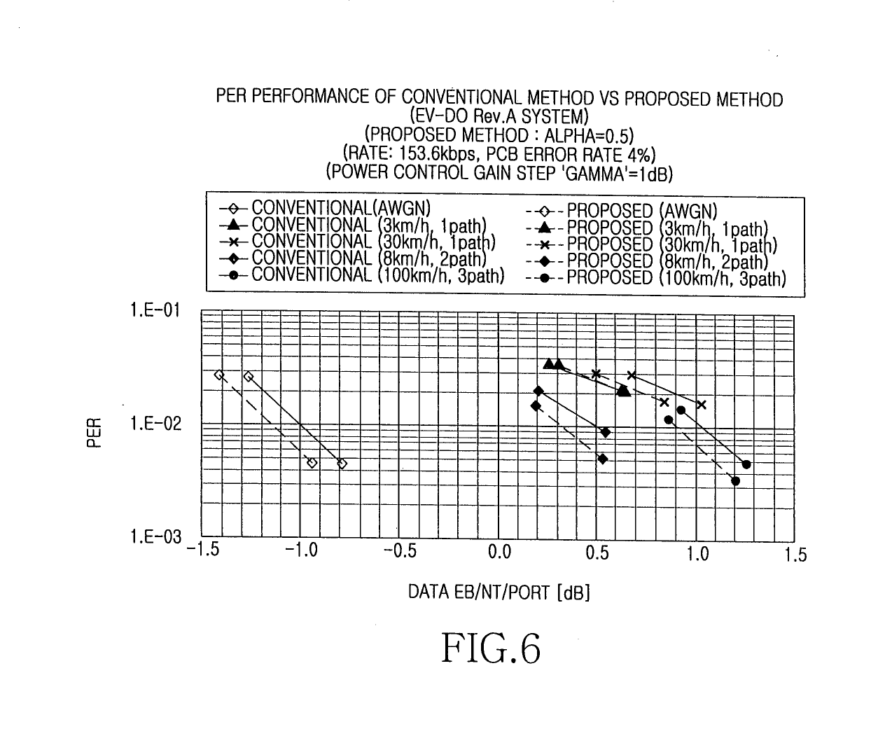

FIG. 6 is a diagram of a performance in the reverse power control according to an embodiment of the present invention.

When the present invention is applied to the fading channel environment of the CDMA 2000 1× Rev. A system, one can see that the performance enhancement of 0.15˜0.2 [dB] is achieved in most of the fading channels.

In the fast closed-loop power control, the RSQI can be accurately measured in spite of the limitation of the short RSQI measurement interval. The accurate RSQI measurement can enhance the decoding performance in the general environments and in most of the fading channels.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An uplink power control method of a base station in a mobile communication system, the method comprising:
receiving a signal from a terminal;
calculating a Received Signal Quality Indicator (RSQI) value using the signal and previous power control information;
comparing the RSQI with a threshold;
determining power control information after the comparison;
sending the power control information to the terminal.

2. The uplink power control method of claim 1, wherein the RSQI value is calculated using the signal and the previous power control information based on the following equation:
RSQI(i)=α·rsqi(i)+(1−α)·β(i−1)·RSQI(i−1)
where RSQI(i) is an RSQI value measured for a half of an i-th power control period, RSQI(i−1) is an RSQI value measured for a half of an (i−1)-th power control period, α is a learning factor of a 1-tap Infinite Impulse Response (IIR) filter, and β is a power control quantity which is determined based on the following equation:
if (PCB(i−1)=UP)β=10^{(γ/10)}
else if (PCB(i−1)=DOWN)β=10^{(-γ/10)}
where γ is one predefined closed-loop power control quantity, of which unit is [dB], and PCB(i−1) is previous power control information.

3. A base station for controlling an uplink power in a mobile communication system, the base station comprising:
a communication module for communicating with other nodes;
a controller receiving a signal from a terminal through the communication module, calculating a Received Signal Quality Indicator (RSQI) value using the signal and previous power control information, determining power control information by comparing the RSQI with a threshold, and sending the power control information to the terminal; and
a storage for storing the RSQI and data of the controller.

4. The base station of claim 3, wherein the controller calculates the RSQI using the signal and the previous power control information based on the following equation:
RSQI(i)=α·rsqi(i)+(1−α)·β(i−1)·RSQI(i−1)
where RSQI(i) is an RSQI value measured for a half of an i-th power control period, RSQI(i−1) is an RSQI value measured for a half of an (i−1)-th power control period, α is a learning factor of a 1-tap Infinite Impulse Response (IIR) filter, and β is a power control quantity which is determined based on the following equation:
if (PCB(i−1)=UP)β=10^{(γ/10)}
else if (PCB(i−1)=DOWN)β=10^{(-γ/10)}
where γ is one predefined closed-loop power control quantity, of which unit is [dB], and PCB(i−1) is previous power control information.

5. The base station of claim 4, wherein the controller comprises:
a gain selector for calculating γ;
a power control information generator for determining the power control information; and
a filter for calculating the RSQI.

6. A system for controlling an uplink power in a mobile communication system, the system comprising:
a terminal for sending a signal with an instructed strength; and
a base station for receiving the signal from the terminal through a communication module, calculating a Received Signal Quality Indicator (RSQI) using the signal and previous power control information, determining power control information by comparing the RSQI with a threshold, and sending the power control information to the terminal.

7. The system of claim 6, wherein the controller calculates the RSQI value using the signal and the previous power control information based on the following equation:
RSQI(i)=α·rsqi(i)+(1−α)·β(i−1)·RSQI(i−1)
where RSQI(i) is an RSQI value measured for a half of an i-th power control period, RSQI(i−1) is an RSQI value measured for a half of an (i−1)-th power control period, α is a learning factor of a 1-tap IIR filter, and β is a power control quantity which is determined based on the following equation:
if (PCB(i−1)=UP)β=10^{(γ/10)}
else if (PCB(i−1)=DOWN)β=10^{(-γ/10)}
where γ is one predefined closed-loop power control quantity, of which unit is [dB], and PCB(i−1) is previous power control information.

8. The system of claim 7, wherein the base station comprises:
a gain selector for calculating γ;
a power control information generator for determining the power control information; and
a filter for calculating the RSQI.

9. A wireless network comprising a plurality of base stations capable of communicating with a plurality of mobile terminals, wherein each base station is capable of controlling uplink power of selected ones of the plurality of mobile terminals, the each base station comprising:
a communication module for communicating with other nodes;
a controller receiving a signal from a mobile terminal through the communication module, calculating a Received Signal Quality Indicator (RSQI) value using the signal and previous power control information, determining power control information by comparing the RSQI with a threshold, and sending the power control information to the terminal; and
a storage for storing the RSQI and data of the controller.

10. The wireless network of claim 9, wherein the controller calculates the RSQI using the signal and the previous power control information based on the following equation:
RSQI(i)=α·rsqi(i)+(1−α)·β(i−1)·RSQI(i−1)
where RSQI(i) is an RSQI value measured for a half of an i-th power control period, RSQI(i−1) is an RSQI value measured for a half of an (i−1)-th power control period, α is a learning factor of a 1-tap Infinite Impulse Response (IIR) filter, and β is a power control quantity which is determined based on the following equation:
if (PCB(i−1)=UP)β=10^{(γ/10)}
else if (PCB(i−1)=DOWN)β=10^{(-γ/10)}
where γ is one predefined closed-loop power control quantity, of which unit is [dB], and PCB(i−1) is previous power control information.

11. The wireless network of claim 10, wherein the controller comprises:
a gain selector for calculating γ;
a power control information generator for determining the power control information; and
a filter for calculating the RSQI.
